(19) United States
(12) Patent Application Publication
(10) Pub. No.: US 2010/0138803 A1
(43) Pub. Date: Jun. 3, 2010

(54) APPARATUS AND METHOD OF SUPPORTING DESIGN OF SEMICONDUCTOR INTEGRATED CIRCUIT

(75) Inventors: Tetsuro Minamiyama, Kanagawa (JP); Kenichi Yoda, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/625,968

(22) Filed: Nov. 25, 2009

(30) Foreign Application Priority Data
Nov. 28, 2008 (JP) 2008-304172

(51) Int. Cl. G06F 17/50

(52) U.S. Cl. 716/14; 716/17; 716/12; 716/8

(57) ABSTRACT

A method of supporting design of a semiconductor integrated circuit, is achieved by generating a data indicating a basic cell and a data indicating a cell group different in logic from the basic cell; and by storing the basic cell indicating data and the cell group indicating data in a library of a storage unit. An outer shape and a position of a wiring pattern of the cell group are same as those of the basic cell. The wiring pattern of the basic cell and the wiring pattern of the cell group contain a wiring obstruction section indicating an area in which a passage wiring is inhibited. When a design change is carried out, the basic cell is replaced by a change cell of the cell group corresponding to the design change.

### INCORPORATION BY REFERENCE

This patent application claims a priority on convention based on Japanese Patent Application No. 2008-304172. The disclosure thereof is incorporated herein by reference.

### BACKGROUND OF THE INVENTION

1. Field of the Invention

The present invention relates to a method of generating data representing a cell (cell data) before designing a semiconductor integrated circuit, and a design method of supporting the design of the semiconductor integrated circuit by use of the cell data.

2. Description of Related Art

In recent years, along with increases in size and operation speed of a semiconductor integrated circuit, a change of a partial circuit configuration of a semiconductor integrated circuit is often carried out. The reasons of this are in that a timing restriction becomes severer in conjunction with a high-speed operation, and a circuit size becomes larger, so that a logic configuration error is likely to occur.

A technique for facilitating such a circuit design change is disclosed in Japanese Patent Application Publication (JP-A-Heisei 4-288717), According to this method, a delay element is constituted by one of basic blocks having a same wiring layout and different delay times. After completion of placement and routing of an entire circuit including the delay element, a simulation is performed. If a predetermined timing restriction is not met, a basic block for a delay element is replaced by another basic block having a different delay time. Thus, timing correction can be carried out without performing the placement and routing again.

In addition, Japanese Patent Application Publication (JP 2000-77635A) discloses a cell layout structure in which wiring layouts of various logic gate cells are partially unified.

In such a conventional technique, a same logic cell can be replaced by each other. However, there is a difference in a wiring layout between different logic cells, and therefore it is difficult to replace the different logic cells by each other. For this reason, when logic is changed in a design change, a placement and routing need be performed again.

### SUMMARY OF THE INVENTION

In an aspect of the present invention, a method of supporting design of a semiconductor integrated circuit, is achieved by generating a data indicating a basic cell and a data indicating a cell group different in logic from the basic cell; and by storing the basic cell indicating data and the cell group indicating data in a library of a storage unit. An outer shape and a position of a wiring pattern of the cell group are same as those of the basic cell. The wiring pattern of the basic cell and the wiring pattern of the cell group contain a wiring obstruction section indicating an area in which a passage wiring is inhibited. When a design change is carried out, the basic cell is replaced by a change cell of the cell group corresponding to the design change.

In another aspect of the present invention, a design supporting apparatus includes a cell data generating section configured to generate a data indicating a basic cell and a data indicating a cell group different in logic from the basic cell; a library; and a library building section configured to store the basic cell indicating data and the cell group indicating data in the library. An outer shape and a wiring pattern position of the cell group are same as those of the basic cell. Each of a wiring pattern in the basic cell and a wiring pattern in the cell group comprises a wiring obstruction section to show an area in which a passage wiring is inhibited. When a design change is carried out, the basic cell is replaced with a change cell of the cell group which corresponds to the design change.

According to the present invention, there are provided a cell data generating method and a design method for a semiconductor circuit in which even if logic is changed, it is not necessary to re-execute a placement and routing.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 illustrates a configuration of a design supporting system for a semiconductor integrated circuit according to an embodiment of the present invention;

FIG. 2 is a flowchart illustrating the design supporting system for the semiconductor integrated circuit according to the embodiment of the present invention;

FIG. 3 is a flowchart illustrating the design supporting method for the semiconductor integrated circuit according to the embodiment of the present invention;

FIG. 4 illustrates a plurality of sets of a basic cell and a group cells stored in a library;

FIG. 5A illustrates a basic cell;

FIG. 5B illustrates a change cell;

FIG. 6A illustrates a circuit configuration of a basic cell;

FIG. 6B illustrates a circuit configuration of a change cell;

FIG. 7A illustrates the basic cell;

FIG. 7B illustrates the change cell;

FIG. 8A illustrates a circuit configuration of a basic cell;

FIG. 8B illustrates a circuit configuration of a change cell;

FIG. 9A illustrates the basic cell; and

FIG. 9B illustrates the change cell.

### DESCRIPTION OF THE EMBODIMENTS

Hereinafter, a design supporting system for a semiconductor integrated circuit according to the present invention will be described in detail with reference to the attached drawings.

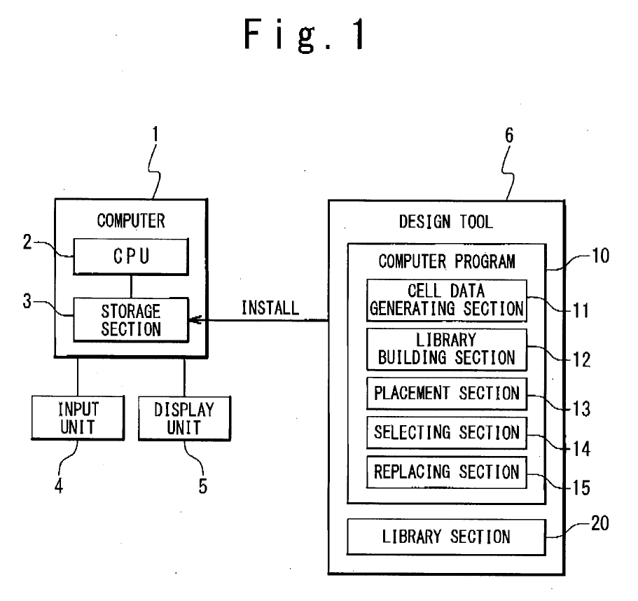

FIG. 1 illustrates a configuration of a design supporting system for the semiconductor integrated circuit according to an embodiment of the present invention. The design supporting system includes a computer 1, and an input unit 4, and a display unit 5, which are connected to the computer 1. The computer 1 includes a storage section 3 in which a computer software program is installed from a recording medium; and a CPU (Central Processing Unit) 2 as an execution section for executing the computer software program.

The design supporting system further includes the recording medium in which a software design tool 6 is recorded. The design tool 6 is installed in the storage section 3. The design tool 6 includes a computer program 10 and a library 20. The computer program 10 includes a cell data generating section 11, a library building section 12, a placement section 13, a selecting section 14, and a replacing section 15.

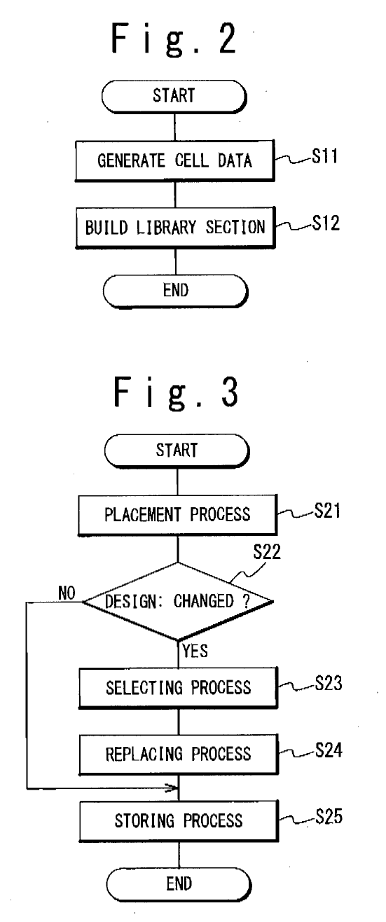

FIG. 2 is a flowchart illustrating a part of a design supporting method for a semiconductor integrated circuit according to the embodiment of the present invention. First, the cell data generating section 11 generates cell data representing each of basic cells and groups of cells based on an operation of the input unit 4 (Step S11). It should be noted that the basic cell and the group of cells corresponding to the basic cell are different in logic. Then, a user uses the input unit 4 to issue a storage instruction to the computer 1. The library building section 12 stores the cell data in the library 20 in response to the storage instruction (Step S12). It should be noted that when the user further adds new cell data to the library 20, the user instructs the computer 1 to again perform Steps S11 and S12. Thus, a plurality of sets of cell data are prepared in the library 20.

FIG. 3 is a flowchart illustrating another part of the design supporting method for the semiconductor integrated circuit according to the embodiment of the present invention.

The user uses the input unit 4 to design the semiconductor integrated circuit. The placement section 13 displays the basic cells and the cell groups in the library 20 on the display unit 5 in response to an operation of the input unit 4. The placement section 13 places a specified one of the basic cells and cells of the cell groups in a layout region to generate layout data in response to the operation of the input unit 4. The placement section 13 displays the layout data on the display unit 5 (Step S21).

If the user carries out a design change (Step S22: YES), the user uses the input unit 4 to issue to the computer 1 a change instruction for carrying out the design change. The selecting section 14 displays the basic cell and cells of the cell group in the library 20 on the display unit 5 in response to the change instruction. The selecting section 14 selects a change cell as one of the cells of the cell group corresponding to the design change (Step S23).

The replacing section 15 replaces the basis cell by the change cell to display it on the display unit 5 (Step S24). It should be noted that if the user further carries out a design change, the user instructs the computer 1 to perform Steps 23 and 24 again. On the other hand, if the user does not carries out the design change (Step 22: NO), or terminates the design change, the user uses the input unit 4 to issue a storage instruction to the computer 1. The replacing section 15 stores the layout data in the storage section 3 according to the storage instruction (Step S25).

It should be noted that the basis cell and the cells of the cell group meet the conditions as described below.

### (Condition 1)

The outer shape of the cells of the cell group are the same as that of the basic cell.

The positions of wiring patterns in the cells of the cell group are the same as that of a wiring pattern in the basic cell.

It should be noted that a cell meeting the condition 1, i.e., a cell having the same outer shape and wiring pattern position is referred to as a footprint cell.

### (Condition 2)

As a data format of a basic cell and the cells of the cell group, GDS is applied. The GDS is a data format for mask layout. As a format for the mask layout, an LEF (Library Exchange Format) is applied.

The wiring patterns of the basic cell and the cells of the group respectively include wiring obstruction sections. The wiring obstruction section refers to an area where a passing wiring is inhibited (OBS: Obstruction), whose LEF is denoted by, for example, “OBS”.

Also, under the condition 2, the wiring patterns of the basic cell and the cells of the cell group further include use common sections. The wiring obstruction section “LEF; OBS” includes a use enable section and a use disable section.

The use common section refers to a portion that is used in common as a circuit.

The use enable section refers to a portion that is individually used as a circuit.

The use disable section refers to a portion that is not used as a circuit, whose GDS is denoted by, for example, “No shape”.

Examples of the use common sections, the use enable section, and the use disable section will be described later.

### (Condition 3)

A basic cell and cells of a group represent logic gate cells. In this case,

The positions of diffusion layers in the cells of the cell group are the same as that of a diffusion layer in the basic cell.

The positions of contacts in the cells of the cell group are the same as that of a contact in the basic cell.

In the following description, a specific example is used to describe a basic cell and a group of cells.

### Example 1

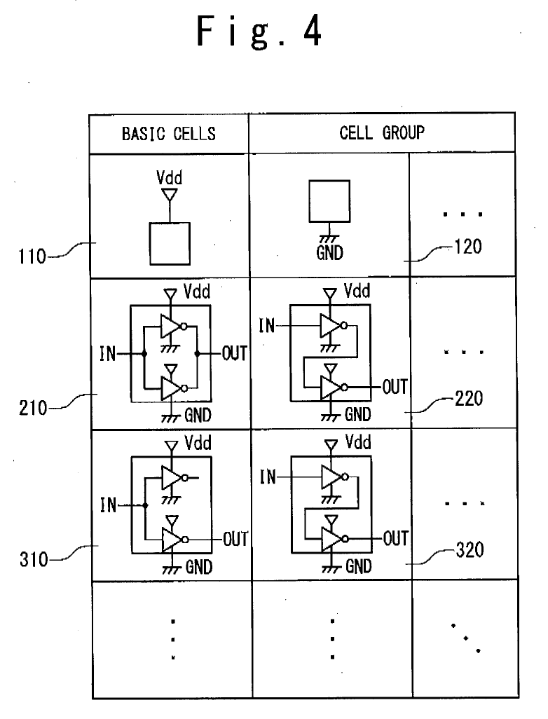

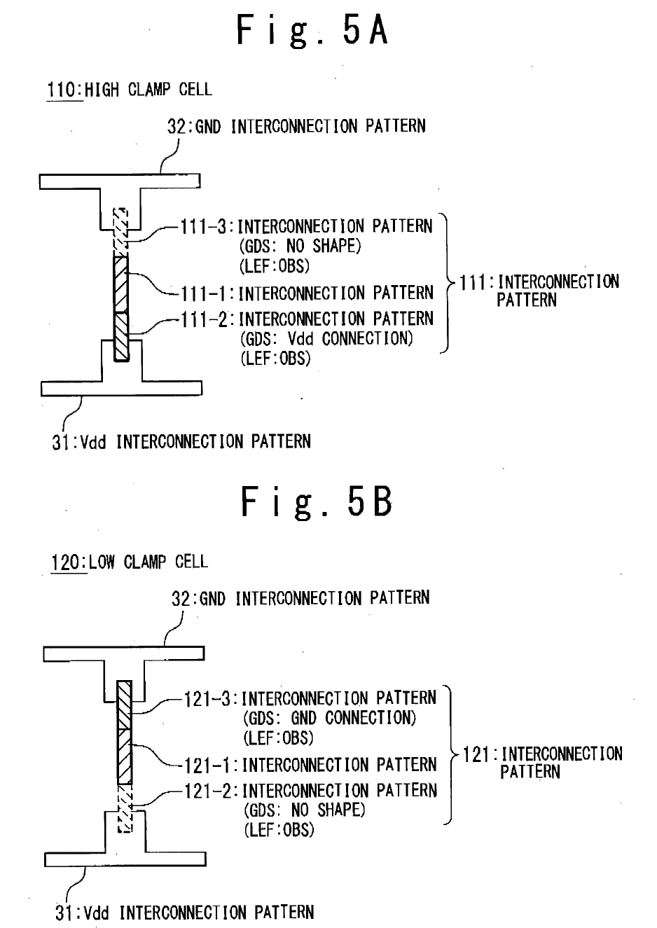

As illustrated in FIGS. 4 and 5A and 5B, it is assumed that, among a plurality of sets of a basic cell and a cell group, a basic cell 110, a cell group 120, . . . represent clamp cells that, are cells connected to a power supply. For example, a first power supply Vdd is connected with a wiring line 31 as shown in FIG. 5A. A second power supply GND, which is lower in a voltage than the first power supply Vdd, is connected with a wiring line 32. The basic cell 110 represents a clamp cell that is a cell connected to the wiring line 31. One cell in the cell groups 120, . . . is assumed to be a change cell. In this case, the change cell represents a clamp cell that is a cell connected to the wiring line 32.

FIG. 5A illustrates the basic cell 110. The basic cell 110 has a wiring pattern 111. The wiring pattern 111 includes wiring pattern sections 111-1, 111-2 and 111-3. The wiring pattern section 111-2 is connected to the wiring line 31. The wiring pattern section 111-3 is connected to the wiring line 32. The wiring pattern section 111-1 is connected between the wiring pattern sections 111-2 and 111-3, The wiring pattern section 111-1 is a portion that is used in common for a High clamp cell and a Low clamp cell. For this reason, the wiring pattern section 111-1 corresponds to the use common section. The wiring pattern section 111-2 is a portion that is individually used for the circuit representing the High clamp cell. For this reason, the wiring pattern section 111-2 corresponds to a use enable section “GDS; Vdd connection, LEF; OBS”. The wiring pattern section 111-3 is a portion that is not used for the circuit representing the High clamp cell. For this reason, the wiring pattern section 111-3 corresponds to a use disable section “GDS; No SHAPE, LEF; OBS”.

For example, when the basic cell 110 is displayed on the display unit 5, the use common sections, the use enable section, and the use disable section are displayed by different figures. For example, when first and second lines are respectively used for the use common section and the use enable section, a third line that is different from the first and second lines is used for the use disable section. Alternatively, if first and second colors are respectively used for the use common section and the use enable section, a third color that is different from the first and second colors is used for the use disable section. This leads to the suggestion that the basic cell 110 meets the condition 2.

FIG. 5B illustrates the change cell 120. The change cell 120 has a wiring pattern 121. The wiring pattern 121 is the same in shape as that 111 of the basic cell 110. The wiring pattern 121 includes wiring pattern sections 121-1 to 121-3. The positions of the wring pattern sections 121-1 to 121-3 are the same as those of the wiring pattern sections 111-1 to 111-3, respectively. That is, the position of the wiring pattern 121 is the same as that of the wiring pattern 111. This leads to the suggestion that a set of the basic cell 110 and the change cell 120 meets the condition 1.

The wiring pattern section 121-1 is a portion that is used in common for circuits representing a High clamp cell and a Low clamp cell. For this reason, the wiring pattern section 121-1 corresponds to the use common section. The wiring pattern section 121-2 is a portion that is not used for the circuit representing the Low clamp cell. For this reason, the wiring pattern section 121-2 corresponds to the use disable section “GDS; No SHAPE, LEF; OBS”. The wiring pattern section 121-3 is a portion that is individually used for the circuit representing the Low clamp cell. For this reason, the wiring pattern section 121-3 corresponds to the use enable section “GDS; GNP connection, LEF; OBS”.

For example, when the change cell 120 is displayed on the display unit 5, the use common section, the use enable section, and the use disable section are displayed by different figures. This is similar to the case where the basic cell 110 is displayed on the display unit 5. This leads to the suggestion that the change cell 120 meets the condition 2. In the present invention, as described above, the condition 1 is met. That is, the outer shape and the wiring pattern position of the change cell are the same as those of the basic cell. This will be described.

For example, if a basic cell and cells of a cell group are the same in logic, it is easy to replace the basic cell by a change cell. However, if the basic cell and the cells of the group are different in logic, it is difficult to replace the basic cell by the change cell. As the reason, in the case of the different logics, there typically exist the following problems:

(Problem 1) The outer shape of each cell of the cell group is different from that of the basic cell.
(Problem 2) The position of a wiring pattern of each cells of the cell group is different from that of a wiring pattern of the basic cell.
For these reasons, when the basic cell is replaced by the change cell, the change should be carried out in consideration of cell locations and routing around the change cell (placement and routing should be performed again).

In the present invention, the condition 2 is further met. That is, even if the basic cell and the cells of the cell group are different in logic, in order to meet the condition 1,

Use common section, and

Wiring obstruction section (the use enable section “LEF; OBS” or the use disable section “GDS; No SHAPE, LEF; OBS”)

are provided in wiring patterns of the basic cell and the cells of the group. Thus, the condition 1 can be met, and also limits the position of a wiring line connected from an outside of the basic cell to the basic cell onto a wiring layout of the basic cell where the wiring obstruction section is absent. According to the present invention, it is not necessary to perform the placement of peripheral cells or the routing again. Also, the smaller number of masks to be replaced than before is only required.

### Example 2

As illustrated in FIG. 4, it is assumed that among the plurality of sets of a basic cell and a cell group, a basic cell 210, a cell group 220, . . . represent logic gate cells. The basic cell 210 represents an inverter cell. One cell 220 in the cell groups 220, . . . is assumed to be a change cell. In this case, the change cell 220 represents a buffer cell as a cell of a type in which an output driving capability is changed for the basic cell 210.

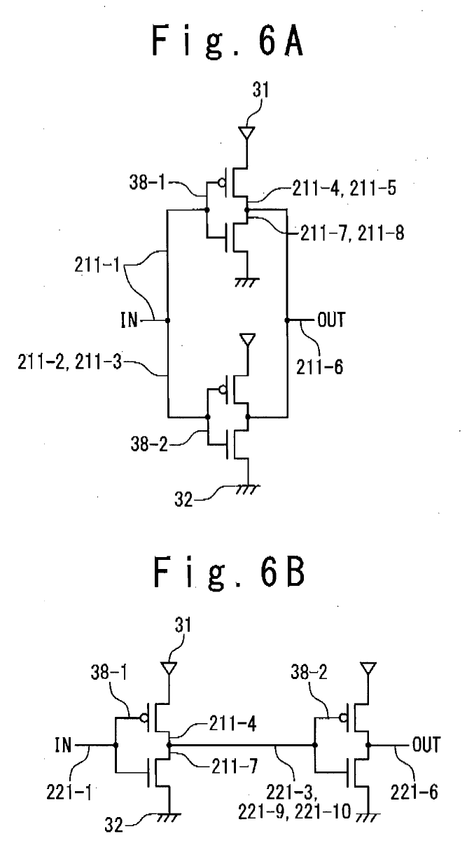

FIG. 6A illustrates a circuit configuration of the basic cell 210. The basic cell 210 has first and second inverters that are connected in parallel. Each of the first and second inverters includes a P-type transistor and an N-type transistor. An input of the second inverter is connected to an input of the first inverter. A signal is supplied to the inputs of the first and second inverters. An output of the second inverter is connected to an output of the first inverter. The above-described signal is inverted by the first and second inverters, and the inverted signal is outputted from the outputs of the first and second inverters.

FIG. 6B illustrates a circuit configuration of the change cell 220, The change cell 220 has first and second inverters that are connected in series. Each of the first and second inverters includes the P-type transistor and the N-type transistor. A signal is supplied to the input of the first inverter. The input of the second inverter is connected to the output of the first inverter. The above-described signal is inverted by the first inverter, then the inverted signal is inverted by the second inverter; and the resulting signal is outputted from the output of the second inverter.

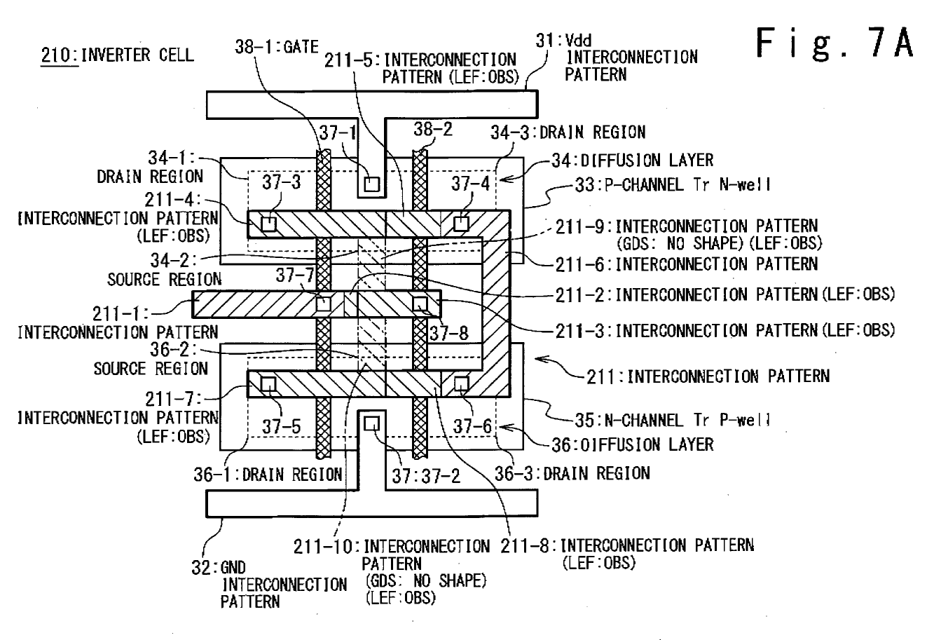

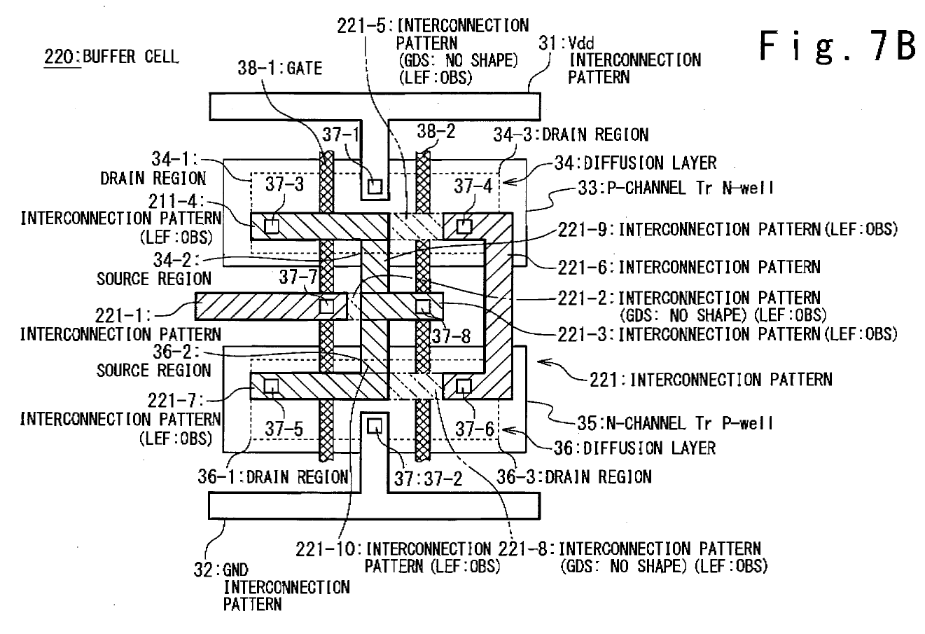

FIG. 7A illustrates the basic cell 210. The basic cell 210 includes an N-type well 33, drain regions 34-1 and 34-3, and a source region 34-2 for the P-type transistors; a P-type well 35, drain regions 36-1 and 36-3, and a source region 36-2 for the N-type transistors; contacts 37-1 to 37-8; and gates 38-1 and 38-2. The N-type well 33 and the P-type well 35 are formed on a surface of a substrate (not shown) to extend in a first direction. The drain region 34-1, the source region 34-2, and a drain region 34-3 for the P-type transistors are formed as diffusion layers on a surface of the N-type well 33. The drain region 36-1, the source region 36-2, and drain region 36-3 for the N-type transistors are formed as diffusion layers on a surface of the P-type well 35.

The gate 38-1 is formed in a layer above the drain region 34-1, the source region 34-2, substrate, the drain region 36-1, and the source region 36-2, to extend in a second direction perpendicular to the first direction. The gate 38-2 is formed in a layer above the source region 34-2, the drain region 34-3, the substrate, the source region 36-2, and the drain region 36-3, to extend in the second direction. The source region 34-2 is connected to the wiring line 31 through the contact 37-1. The source region 34-2 is connected to the wiring line 32 through the contact 37-2.

The drain region 34-1, the gate 38-1, and the source region 34-2 correspond to the P-type transistor of the first inverter. The source region 34-2, the gate 38-2, and the drain region 34-3 correspond to the P-type transistor of the second inverter. The drain region 36-1, the gate 38-1, and the source region 36-2 correspond to the N-type transistor of the first inverter. The source region 36-2, the gate 38-2, and the drain region 36-3 correspond to the N-type transistor of the second inverter.

The basic cell 210 further includes a wiring pattern 211. The wiring pattern 211 includes wiring pattern sections 211-1 to 211-10. The wiring pattern section 211-1 is formed in a layer above the substrate and the gate 38-1, to extend in the first direction from one end section to the other end section. The wiring pattern section 211-1 is connected to the gate 38-1 through the contact 37-7. The wiring pattern section 211-2 is formed in a layer above the substrate, to extend in the first direction from one end section to the other end section, The one end section of the wiring pattern section 211-2 is connected to the other end section of the wiring pattern section 211-1. The wiring pattern section 211-3 is formed in a layer above the substrate and the gate 38-2, to extend in the first direction from one end section to the other end section. The one end section of the wiring pattern section 211-3 is connected to the other end section of the wiring pattern section 211-2. The wiring pattern section 211-3 is connected to the gate 38-2 through the contact 37-8.

The wiring pattern section 211-4 is formed in a layer above the drain region 34-1, the gate 38-1, and the source region 34-2, to extend in the first direction from one end section to the other end section. The wiring pattern section 211-4 is connected to the drain region 34-1 through the contact 37-3. The wiring pattern section 211-5 is formed in a layer above the source region 34-2, the gate 38-2, and the drain region 34-3, to extend in the first direction from one end section to the other end section. The one end section of the wiring pattern section 211-5 is connected to the other end section of the wiring pattern section 211-4. The wiring pattern section 211-7 is formed in a layer above the drain region 36-1, the gate 38-1, and the source region 36-2, to extend in the first direction from one end section to the other end section. The wiring pattern section 211-7 is connected to the drain region 36-1 through the contact 37-5. The wiring pattern section 211-8 is formed in a layer above the source region 36-2, the gate 38-2, and the drain region 36-3, to extend in the first direction from one end section to the other end section. The one end section of the wiring pattern section 211-8 is connected to the other end section of the wiring pattern section 211-7.

The wiring pattern section 211-6 includes a first wiring pattern portion, a second wiring pattern portion, and a third wiring pattern portion. The first wiring pattern portion is formed in a layer above the drain region 34-3, to extend in the first direction from one end section to the other end section. The one end section of the first wiring pattern portion is connected to the other end section of the wiring pattern section 211-5. The first wiring pattern portion is connected to the drain region 34-3 through the contact 37-4. The second wiring pattern portion is formed in a layer above the drain region 36-3, to extend in the first direction from one end section to the other end section. The one end section of the second wiring pattern portion is connected to the other end section of the wiring pattern section 211-8. The second wiring pattern portion is connected to the drain region 36-3 through the contact 37-6. The third wiring pattern portion is formed in a layer above the drain region 34-3, the substrate, and the drain region 36-3, to extend in the second direction from one end section to the other end section. The one end section of the third wiring pattern portion is connected to the other end section of the first wiring pattern portion. The other end section of the third wiring pattern portion is connected to the other end section of the second wiring pattern portion.

The wiring pattern section 211-9 is formed in a layer above the source region 34-2 and the substrate, to extend in the second direction from one end section to the other end section. The one end section of the wiring pattern section 211-9 is connected to the wiring pattern section 211-4. The other end section of the wiring pattern section 211-9 is connected to the wiring pattern section 211-3. The wiring pattern section 211-10 is formed in a layer above the substrate and source region 36-2, to extend in the second direction from one end section to the other end section. The one end section of the wiring pattern section 211-10 is connected to the wiring pattern section 211-3. The other end section of the wiring pattern section 211-10 is connected to the wiring pattern section 211-7.

The wiring pattern section 211-1 represents the input of the first inverter (see FIG. 6A). The wiring pattern section 211-1 is a portion common to the inverter cell and the buffer cell. For this reason, the wiring pattern section 211-1 corresponds to the use common section. A set of the wiring pattern sections 211-2 and 211-3 represents the input of the second inverter (see FIG. 6A). The set of the wiring pattern sections 211-2 and 211-3 is a portion that is individually used for the inverter cell. For this reason, the set of the wiring pattern sections 211-2 and 211-3 corresponds to the use enable section “LEF; OBS”. A set of the wiring pattern sections 211-4 and 211-5 represents a drain of the P-type transistor of the first inverter (see FIG. 6A). The set of the wiring pattern sections 211-4 and 211-5 is a portion that is individually used for the inverter cell. For this reason, the set of the wiring pattern sections 211-4 and 211-5 corresponds to the use enable section “LES'; OBS”.

A set of the wiring pattern sections 211-7 and 211-8 represents a drain of the N-type transistor of the first inverter (see FIG. 6A). The set of the wiring pattern sections 211-7 and 211-B is a portion that is individually used for the inverter cell. For this reason, the set of the wiring pattern sections 211-7 and 211-8 corresponds to the use enable section “LEF; OBS”. The wiring pattern section 211-6 represents drains of the P-type and N-type transistors of the second inverter as the output of the second inverter (see FIG. 6A). The wiring pattern section 211-6 is a portion that is used in common for the logic gate cells. For this reason, the wiring pattern section 211-6 corresponds to the use common section. A set of the wiring pattern sections 211-9 and 211-10 is a portion that is not used for the inverter cell. For this reason, the set of the wiring pattern sections 211-9 and 211-10 corresponds to the use disable section “GDS; No SHAPE, LEF; OBS”.

For example, when the basic cell 210 is displayed on the display unit 5, the use common section, the use enable section, and the use disable section are displayed by different figures. This is similar to the above-described case where the basic cell 110 is displayed on the display unit 5. This leads to the suggestion that the basic cell 210 meets the condition 2.

FIG. 7B illustrates the change cell 220. The change cell 220 has a wiring pattern 221. The wiring pattern 221 is the same in shape as that 211 of the basic cell 210. The wiring pattern 221 includes wiring pattern section 221-1 to 221-10. The positions of the wiring pattern sections 221-1 to 221-10 are the same as those of the wiring pattern sections 211-1 to 211-10, respectively. That is, a position of the wiring pattern 221 is the same as that of the wiring pattern 211. This leads to the suggestion that a set of the basic cell 210 and change cell meets the condition 1.

The wiring pattern section 221-1 represents the input of the first inverter (see FIG. 6B). The wiring pattern section 221-1 is a portion that is used in common for the inverter cell and the buffer cell. For this reason, the wiring pattern section 221-1 corresponds to the use common section. The wiring pattern section 221-4 represents a drain of the P-type transistor of the first inverter (see FIG. 6B). The wiring pattern section 221-4 is a portion that is individually used for the buffer cell. For this reason, the wiring pattern section 221-4 corresponds to the use enable section “LEF; OBS”. The wiring pattern section 221-7 represents a drain of the N-type transistor of the first inverter (see FIG. 6B). The wiring pattern section 221-7 is a portion that is individually used for the buffer cell. For this reason, the wiring pattern section 221-7 corresponds to the use enable section “LEF; OBS”.

A set of the wiring pattern sections 221-3, 221-9, and 221-10 represents the input of the second inverter (see FIG. 6B). The set of the wiring pattern sections 221-3, 221-9, and 221-10 is a portion that is individually used for the buffer cell. For this reason, the set of the wiring pattern sections 221-3, 221-9, and 221-10 corresponds to the use enable section “LEF; OBS”. The wiring pattern section 221-6 represents drains of the P-type and N-type transistors of the second inverter as the output of the second inverter (see FIG. 6B). The wiring pattern section 221-6 is a portion that is used in common for the inverter cell and the buffer cell. For this reason, the wiring pattern section 221-6 corresponds to the use common section. A set of the wiring pattern sections 221-2, 221-5, and 221-8 is a portion that is not used for the buffer cell. For this reason, the set of the wiring pattern sections 221-2, 221-5, and 221-8 corresponds to the use disable section “GDS; No SHAPE, LEF; OBS”.

For example, if the change cell 220 is displayed on the display unit 5, the use common section, the use enable section, and the use disable section are displayed by different figures. This is similar to the above-described case where the basic cell 110 is displayed on the display unit 5. This leads to the suggestion that the change cell 220 meets the condition 2.

Also, from the conditions 1 and 2, the change cell 220 can be directly applied with the diffusion layers of the basic cell 210 (the drain region 34-1, the source region 34-2, the drain region 34-3, the drain region 36-1, the source region 36-2, and the drain region 36-3). That is, the positions of the diffusion layers 34-1 to 34-3, and 36-1 to 36-3 of the change cell 220 are the same as those 34-1 to 34-3, and 36-1 to 36-3 of the basic cell 210.

Also, the change cell 220 can be directly applied with the gates 38-1 and 38-2, and contacts 37-1 to 37-8 of the basic cell 210. That is, positions of the gates 38-1 and 38-2 of the change cell 220 are the same as those of the gates 38-1 and 38-2 of the basic cell 210. The positions of the contacts 37-1 to 37-8 of the change cell 220 are the same as those of the contacts 37-1 to 37-8 of the basic cell 210. This leads to the suggestion that the set of the basic cell 210 and the change cell 220 meets the condition 3.

In the present invention, as described above, the condition 2 is met in addition to the condition 1. For this reason, according to the present invention, when a basic cell is replaced by a change cell, it is not necessary to perform placement of cells peripheral to the change cell, or routing again. Also, the smaller number of masks to be replaced is only required than before.

In the present invention, even if the conditions 1 and 2 are met, it may be inconvenient to replace the basic cell with the change cell under the condition that the basic cell and the cell group represent logic gate cells. As the reason, in the case of different logics, there further exists a problem, i.e., (Problem 3) that the position of a diffusion layer of each cell in a cell group is different from that of a diffusion layer of the basic cell.

In the present invention, the condition 3 is further met as described above. That is, if the basic cell and the cells of the group are logic gate cells, to make it possible to replace the basic cell by the change cell,

the positions of diffusion layers of the cells of the group are set to the same as that of a diffusion layer of the basic cell, and

the positions of contacts of the cells of the group are set to the same as that of a contact of the basic cell.

Therefore, according to the present invention, even if the basic cell and the cells of the group are logic gate, cells, it is not necessary to perform a placement of the peripheral cells, or routing again. Also, the smaller number of masks to be replaced is only required than before.

### Example 3

As illustrated in FIG. 4, it is assumed that among the plurality of sots of a basic cell and cell group, the basic cell 310, the cell group 320, . . . represent logic gate cells. It is assumed that the basic cell 310 is an inverter cell, and one cell 320 in the cell group 320, . . . is a change cell. In this case, the change cell 320 represents a buffer cell as a cell of a type in which an output driving capability is not changed for the basic cell 310.

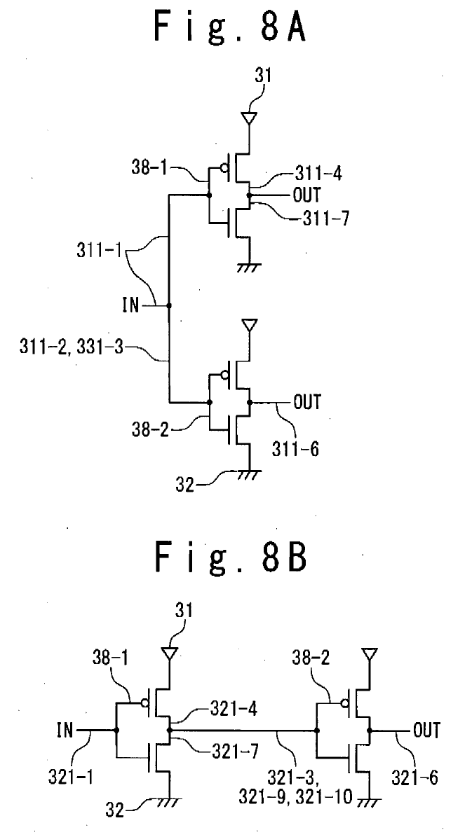

FIG. 8A illustrates a circuit configuration of the basic cell 310. The basic cell 310 is different from that 210 in that an output of a second one of first and second inverters is used. FIG. 8B illustrates a circuit configuration of the change cell 320. The change cell 320 is the same as change cell 220.

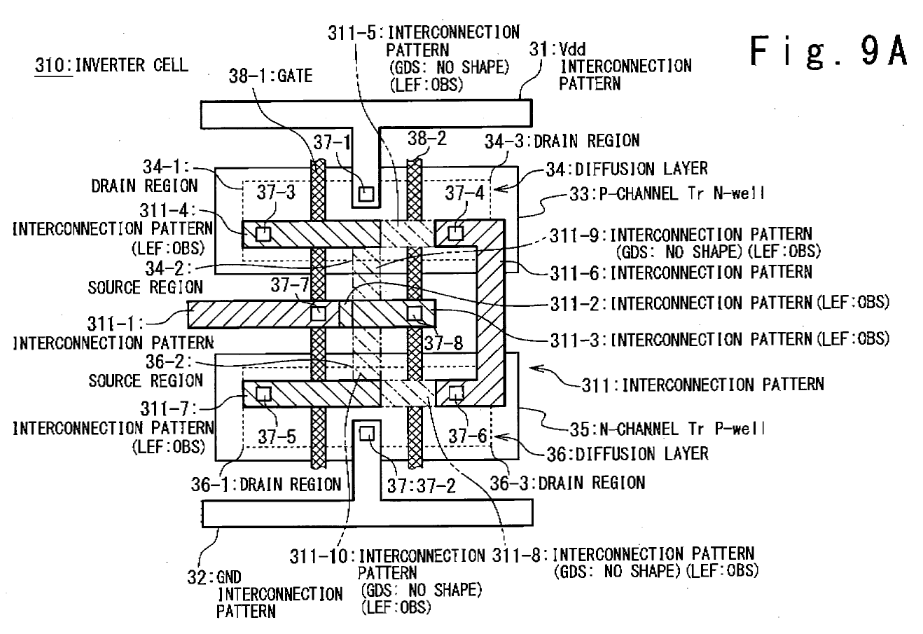

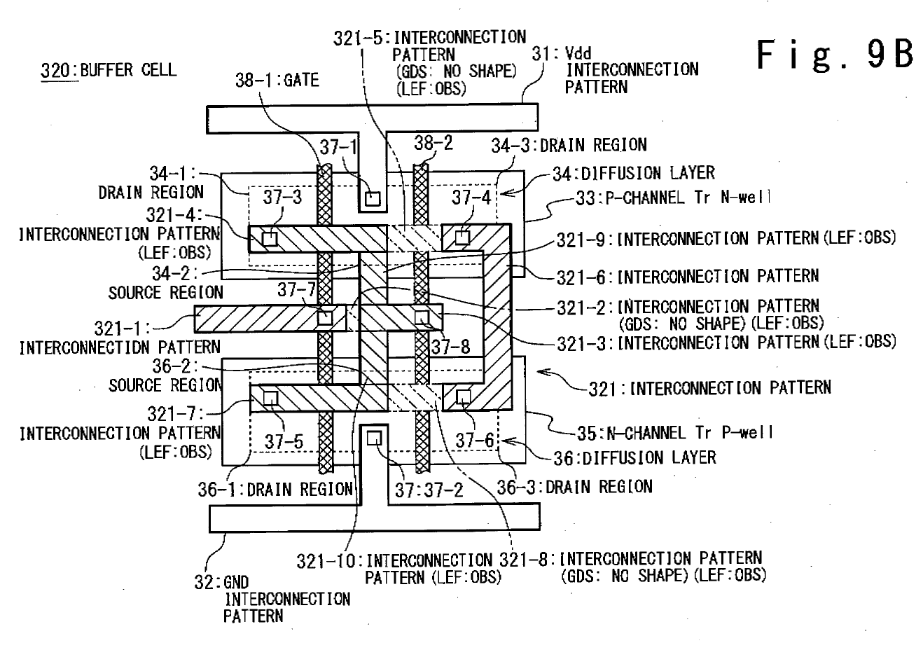

FIG. 9A illustrates the basic cell 310. The basic cell 310 has a wiring pattern 311. The wiring pattern 311 is the same in shape as the wiring pattern 211 of the above-described basic cell 210. The basic cell 310 includes wiring pattern sections 311-1 to 311-10. The position of the wiring pattern sections 311-1 to 311-10 are the same as those of the wiring pattern sections 211-1 to 211-10 of the basic cell 210, respectively. That is, a position of the wiring pattern 311 is the same as that of the wiring pattern 211.

The wiring pattern section 311-1 represents an input of the first inverter (see FIG. 8A). The wiring pattern section 311-1 is a portion that is used in common for the inverter cell and the buffer cell. For this reason, the wiring pattern section 311-1 corresponds to the use common section. A set of the wiring pattern sections 311-2 and 311-3 represents an input of the second inverter (see FIG. BA). The set of the wiring pattern sections 311-2 and 311-3 is a portion that is individually used for the inverter cell. For this reason, the set of the wiring pattern sections 311-2 and 311-3 corresponds to the use enable section “LEF; OBS”.

The wiring pattern section 311-4 represents a drain of a P-type transistor of the first inverter (see FIG. 8A). The wiring pattern section 311-4 is a portion that is individually used for the inverter cell. For this reason, the wiring pattern section 311-4 corresponds to the use enable section “LEF; OBS”. The wiring pattern 311-7 represents a drain of an N-type transistor of the first inverter (see FIG. 8A). The wiring pattern section 311-7 is a portion that is individually used for the inverter cell. For this reason, the wiring pattern section 311-7 corresponds to the use enable section “LEF; OBS”. The wiring pattern section 311-6 represents drains of the P-type and N-type transistors of the second inverter as the output of the second inverter (see FIG. 8A). The wiring pattern section 311-6 is a portion that is used in common for the inverter cell and buffer cell. For this reason, the wiring pattern section 311-6 corresponds to the Use common section. A set of the wiring pattern section 311-5, 311-8, 311-9, and 311-10 is a portion that is not used for the inverter cell. For this reason, the set of the wiring pattern section 311-5, 311-8, 311-9, and 311-10 corresponds to the use disable section “GDS; No SHAPE, LEF; OBS”.

For example, when the basic cell 310 is displayed on the display unit 5, the use common section, the use enable section, and the use disable section are displayed by different figures. This is similar to the above-described case where the basic cell 110 is displayed on the display unit 5. This leads to the suggestion that the basic cell 310 meets the condition 2.

FIG. 9B illustrates the change cell 320. The change cell 320 has a wiring pattern 321. The wiring pattern 321 is the same in shape as that 311 of the basic cell 310. The wiring pattern 321 includes wiring pattern sections 321-1 to 321-10. The positions of the wiring pattern sections 321-1 to 321-10 are the same as those 311-1 to 311-10, respectively. That is, a position of the wiring pattern 321 the same as that of the wiring pattern 311. This leads to the suggestion that a set of the basic cell 310 and the change cell 320 meets the condition 1.

The wiring pattern section 321-1 represents an input of a first inverter (see FIG. 8B). The wiring pattern section 321-1 is a portion that is used in common for the inverter cell and buffer cell. For this reason, the wiring pattern section 321-1 corresponds to the use common section. The wiring pattern section 321-4 represents a drain of a P-type transistor of the first inverter (see FIG. 8B). The wiring pattern section 321-4 is a portion that is individually used for the buffer cell. For this reason, the wiring pattern section 321-4 corresponds to the use enable section “LEF; OBS”. The wiring pattern section 321-7 represents a drain of an N-type transistor of the first inverter (see FIG. 8B). The wiring pattern section 321-7 is a portion that is individually used for the buffer cell. For this reason, the wiring pattern section 321-7 corresponds to the use enable section “LEF; OBS”.

A set of the wiring pattern sections 321-3, 321-9, and 321-10 represents an input of a second inverter (see FIG. 8B). The set of the wiring pattern sections 321-3, 321-9, and 321-10 is a portion that is individually used for the buffer cell. For this reason, the set of the wiring pattern sections 321-3, 321-9, and 321-10 corresponds to the use enable section “LEF; OBS”. The wiring pattern section 321-6 represents drains of the P-type and N-type transistors of the second inverter as an output of the second inverter (see FIG. 8B). The wiring pattern section 321-6 is a portion that is used in common for the inverter cell and buffer cell. For this reason, the wiring pattern section 321-6 corresponds to the use common section. A set of the wiring pattern sections 321-2, 321-5, and 321-8 is a portion that is not used for the buffer cell. For this reason, the set of the wiring pattern sections 321-2, 321-5, and 321-8 corresponds to the use disable section “GDS; No SHAPE, LEF; OBS”.

For example, if the change cell 320 is displayed on the display unit 5, the use common section, the use enable section, and the use disable section are displayed by different figures. This is similar to the above-described case where the basic cell 110 is displayed on the display unit 5. This leads to the suggestion that the change cell 320 meets the condition 2.

Also, from the conditions 1 and 2, the change cell 320 can be directly applied with diffusion layers 34-1 to 34-3, and 36-1 to 36-3, gates 38-1 and 38-2, and contacts 37-1 to 37-8 of the basic cell 310. That is, the positions of diffusion layers 34-1 to 34-3, and 36-1 to 36-3 of the change cell 320 are the same as those of the diffusion layers 34-1 to 34-3, and 36-1 to 36-3 of the basic cell 310. The positions of gates 38-1 and 38-2 of the change, cell 320 are the same as those of the gates 38-1 and 38-2 of the basic cell 310. The positions of contacts 37-1 to 37-8 of the change cell 320 are the same as those of the contact 37-1 to 37-8 of the basic cell 310. This leads to the suggestion that the set of the basic cell 310 and change cell 320 meets the condition 3.

In the present invention, as described above, the condition 2 is met in addition to the condition 1. For this reason, when a basic cell is replaced by a change cell, it is not necessary to reattempt a placement of cells peripheral to the change cell, or routing. Also the smaller number of masks to be replaced is only required than before.

In the present invention, as described above, the condition 3 is further met. Therefore, according to the present invention, even if a basic cell and cells of a cell group represent logic gate cells, it is not necessary to reattempt the placement of the peripheral cells, oz routing. Also, the smaller number of masks to be replaced is only required than before.

Although the present invention has been described above in connection with several embodiments thereof, it would be apparent to those skilled in the art that those embodiments are provided solely for illustrating the present invention, and should not be relied upon to construe the appended claims in a limiting sense.

What is claimed is:

1. A method of supporting design of a semiconductor integrated circuit, comprising:
generating a data indicating a basic cell and a data indicating each of cells of a cell group different in logic from said basic cell; and
storing the data indicating said basic cell and the cells of said group cell indicating data in a library of a storage unit,
wherein an outer shape and a position of a wiring pattern of each cell of the cell group are same as those of said basic cell,
the wiring pattern of said basic cell and the wiring pattern of each cell of said cell group contain a wiring obstruction section indicating an area (OBS; Obstruction) in which a passage wiring is inhibited, and
when a design change is carried out, said basic cell is replaced by a change cell of said cell group in response to said design change.

2. The method according to claim 1, wherein each of the wiring pattern of said basic cell and the wiring pattern of said cell group further comprises a use common section, which shows a portion used in common for a circuit, and
each of the wiring obstruction section of said basic cell and the wiring obstruction section of each cell of said cell group further comprises:
a use enable section which shows a portion individually used for the circuit, and
a use disable section which shows a portion which is not used for the circuit.

3. The method according to claim 2, wherein each of said basic cell and the cells of said cell group comprises a diffusion layer, and
the position of said diffusion layer in each cell of said cell group is same as that of said diffusion layer in said basic cell.

4. The method according to claim 3, wherein each of said basic cell and the cells of said cell group further comprises a gate which is provided between said diffusion layer and said wiring pattern, and
the position of said gate in each cell of said cell group is same as that of said gate in said basic cell.

5. The method according to claim 4, wherein each of said basic cell and the cells of said cell group further comprises:
a first contact configured to connect said diffusion layer and said wiring pattern; and
a second contact configured to connect said gate and said wiring pattern, and
the positions of said first and second contacts in each cell of said cell group are same as those of said first and second contacts in said basic cell.

6. The method according to claim 2, wherein said basic cell and the cells of said cell group cell are for clamp cells which are connected with a power supply, and
each of said wiring pattern of said basic cell and said wiring pattern of said change cell of said cell group comprises:
a first wiring pattern section connected with a first power supply and corresponding to said use enable section and said use disable section;
a second wiring pattern section connected with a second power supply and corresponding to said use enable section and said use disable section; and
a wiring pattern section corresponding to the use common section and connected between the first wiring pattern section and said second wiring pattern section.

7. The method according to claim 2, wherein said basic cell and each cell of said cell group cell are for logic gate cells, and
each of said wiring pattern of said basic cell and said wiring pattern of said change cell of said cell group comprises:
a first wiring pattern section corresponding to the use common section and configured to receive a signal;
a second wiring pattern section corresponding to the use common section and configured to output a signal; and
a wiring pattern section of a wiring pattern other than said first wiring pattern section and said second wiring pattern section and corresponding to the wiring obstruction section.

8. The method according to claim 1, further comprising:
referring to said library to place said basic cell in a layout area,
referring to said library in response to a design change to select a change cell for the design change from said cell group; and
replacing said basic cell with said change cell.

9. A design supporting apparatus for a semiconductor integrated circuit, comprises:
a cell data generating section configured to generate a data indicating a basic cell and a data indicating each of cells of a cell group different in logic from said basic cell;
a library; and
a library building section configured to store the data indicating the basic cell and the cells of the group cell in said library,
wherein an outer shape and a wiring pattern position in each cell of said cell group is same as those of said basic cell,
each of a wiring pattern in said basic cell and a wiring pattern in each cell of said cell group comprises a wiring obstruction section to show an area in which a passage wiring is inhibited,
when a design change is carried out, said basic cell is replaced with a change cell of said cell group in response to said design change.

10. The design supporting apparatus according to claim 9, wherein each of the wiring pattern of said basic cell and the wiring pattern of each cell of said cell group further comprises a use common section, which shows a portion used in common for a circuit, and
each of the wiring obstruction section of said basic cell and the wiring obstruction section of each cell of said cell group further comprises:
a use enable section which shows a portion individually used for the circuit, and
a use disable section which shows a portion which is not used for the circuit.

11. The design supporting apparatus according to claim 10, wherein each of said basic cell and the cells of said cell group comprises a diffusion layer, and
the position of said diffusion layer in each cell of said cell group is same as that of said diffusion layer in said basic cell.

12. The design supporting apparatus according to claim 11, wherein each of said basic cell and the cells of said cell group further comprises a gate which is provided between said diffusion layer and said wiring pattern, and
the position of said gate in each cell of said cell group is same as that of said gate in said basic cell.

13. The design supporting apparatus according to claim 12, wherein each of said basic cell and the cells of said cell group further comprises:
a first contact configured to connect said diffusion layer and said wiring pattern; and
a second contact configured to connect said gate and said wiring pattern, and
the positions of said first and second contacts in each cell of said cell group are same as those of said first and second contacts in said basic cell.

14. The design supporting apparatus according to claim 10, wherein said basic cell and the cells of said cell group are for clamp cells which are connected with a power supply, and
each of said wiring pattern of said basic cell and said wiring pattern of said change cell of said cell group comprises:
a first wiring pattern section connected with a first power supply and corresponding to said use enable section and said use disable section;
a second wiring pattern section connected with a second power supply and corresponding to said use enable section and said use disable section; and
a wiring pattern section corresponding to the use common section and connected between the first wiring pattern section and the second wiring pattern section.

15. The design supporting apparatus according to claim 10, wherein said basic cell and the cells of said cell group cell are for logic gate cells, and
each of said wiring pattern of said basic cell and said wiring pattern of said change cell of said cell group comprises:
a first wiring pattern section corresponding to the use common section and configured to receive a signal;
a second wiring pattern section corresponding to the use common section and configured to output a signal; and
a wiring pattern section of a wiring pattern other than said first wiring pattern section and said second wiring pattern section and corresponding to the wiring obstruction section.

16. The design supporting apparatus according to claim 9, further comprising:
a placement section configured to refer to said library and to place said basic cell in a layout area;
a selecting section configured to refer to said library in response to a design change, to select a change cell of said cell group which corresponds to said design change; and
a replacing section configured to replace said basic cell with said change cell.

17. A computer-readable recording medium in which a computer-executable program code is stored to realize a method of supporting design of a semiconductor integrated circuit, wherein said method comprises:
generating a data indicating a basic cell and a data indicating each of cells of a cell group different in logic from said basic cell; and
storing the data indicating said basic cell and the cells of said group cell indicating data in a library of a storage unit,
wherein an outer shape and a position of a wiring pattern of each cell of the cell group are same as those of said basic cell,
the wiring pattern of said basic cell and the wiring pattern of each cell of said cell group contain a wiring obstruction section indicating an area (OBS; Obstruction) in which a passage wiring is inhibited, and
when a design change is carried out, said basic cell is replaced by a change cell of said cell group in response to said design change.

18. The computer-readable recording medium according to claim 17, wherein each of the wiring pattern of said basic cell and the wiring pattern of said cell group further comprises a use common section, which shows a portion used in common for a circuit, and
each of the wiring obstruction section of said basic cell and the wiring obstruction section of each cell of said cell group further comprises:
a use enable section which shows a portion individually used for the circuit, and
a use disable section which shows a portion which is not used for the circuit.

19. The computer-readable recording medium according to claim 17, further comprising:
referring to said library to place said basic cell in a layout, area,
referring to said library in response to a design change to select a change cell for the design change from said cell group; and
replacing said basic cell with said change cell.
